(19) United States
(12) Patent Application Publication
(10) Pub. No.: US 2013/0080889 A1
(43) Pub. Date: Mar. 28, 2013

(54) ELECTRONIC DEVICE AND AGENDA MANAGEMENT METHOD

(71) Applicants: SHU-PING CHEN, Tu-Cheng (TW); HSIAO-PING CHIU, Tu-Cheng (TW); CHUN-TANG HSU, Tu-Cheng (TW); HSUEH-TSEN TSAI, Tu-Cheng (TW)

(72) Inventors: SHU-PING CHEN, Tu-Cheng (TW); HSIAO-PING CHIU, Tu-Cheng (TW); CHUN-TANG HSU, Tu-Cheng (TW); HSUEH-TSEN TSAI, Tu-Cheng (TW)

(73) Assignee: HON HAI PRECISION INDUSTRY CO., LTD., Tu-Cheng (TW)

(21) Appl. No.: 13/334,101

(22) Filed: Dec. 22, 2011

(30) Foreign Application Priority Data
Sep. 26, 2011 (TW) 100134679

(51) Int. Cl. G06F 3/048; G06F 3/01

(52) U.S. Cl. 715/702; 715/834

(57) ABSTRACT

In an agenda management method of an electronic device, one or more items of an agenda are set, and a time period and an alarm time is set for each of the items. A user interface is displayed for the setting of the agenda, and an analog clock is displayed on the user interface. An area on the analog clock is determined for each item to show the item according to the time when it will happen, and a first color is displayed in each determined area. A user of the electronic device is notified when a prior warning time of any item is reached, and a second color is displayed in the determined area of the item. A third color is displayed in the determined area of the item when the starting time of the item has been reached.

### BACKGROUND

1. Technical Field

Embodiments of the present disclosure relate generally to information management, and particularly to an electronic device and an agenda management method of the electronic device.

2. Description of Related Art

Many electronic devices, such as mobile phones, and personal digital assistants (PDAs), provide agenda functions for users to establish agendas. The agendas may remind users to attend a meeting, and visit friends, for example. Most of the agenda functions remind the user by generating ringtones and vibrations. However, that simple reminding method is crude and not attractive to the user.

### BRIEF DESCRIPTION OF THE DRAWINGS

FIG. 1 is a schematic diagram illustrating one embodiment of an electronic device comprising an agenda management system.

FIG. 2 to FIG. 4 are schematic diagrams illustrating an example of a displayed user interface for items of in an agenda of the electronic device of FIG. 1.

FIG. 5 is a flowchart of one embodiment of an agenda management method of the electronic device of FIG. 1.

### DETAILED DESCRIPTION

The disclosure, including the accompanying drawings, is illustrated by way of example and not by way of limitation. It should be noted that references to “an” or “one” embodiment in this disclosure are not necessarily to the same embodiment, and such references mean at least one.

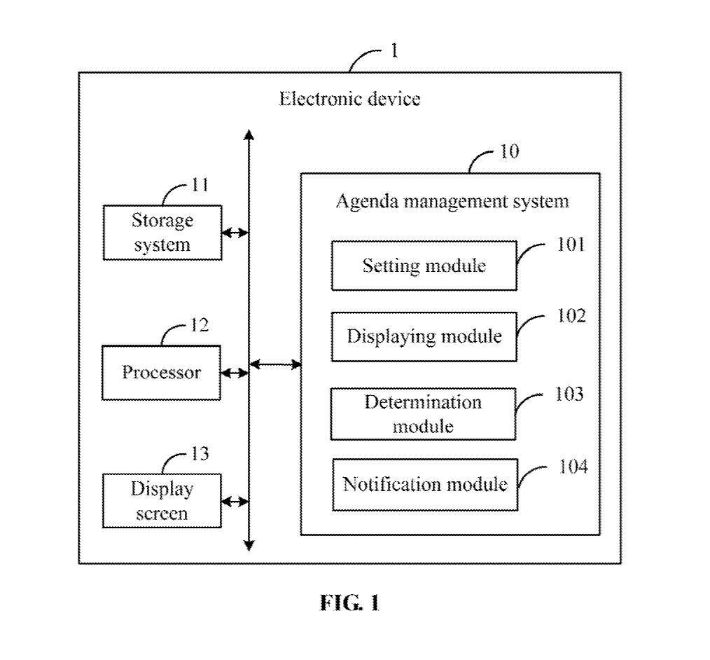

FIG. 1 is a schematic diagram illustrating one embodiment of an electronic device 1 comprising an agenda management system 10. In the embodiment, the electronic device 1 further includes a storage system 11, a processor 12, and a display screen 13. In one embodiment, the electronic device 1 may be, for example, a mobile phone or a personal digital assistant (PDA). It is understood that FIG. 1 is only one example of the electronic device 1, and the electronic device 1 can include more or fewer components than those shown in the embodiment, or have a different configuration of the various components.

The agenda management system 10 may include a plurality of programs in the form of one or more computerized instructions stored in the storage system 11 and executed by the processor 12 to perform operations of the electronic device 1. In the embodiment, the agenda management system 10 includes a setting module 101, a displaying module 102, a determination module 103, and a notification module 104. In general, the word “module”, as used herein, refers to logic embodied in hardware or firmware, or to a collection of software instructions, written in a programming language, such as, Java, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable medium include CDs, DVDs, BLU-RAY, flash memory, and hard disk drives.

The setting module 101 sets one or more items of an agenda in the electronic device 1, and sets an applicable time period and an alarm time for each of the items. For example, the setting module 101 may set a meeting as one item in the agenda and an interview as another item in the agenda. The time period of the meeting may be 10 a.m. to 11 a.m., and the time period of the interview may be 1 p.m. to 2 p.m. The respective alarm times of the meeting and the interview may be set as 9.40 a.m. and 12.40 p.m..

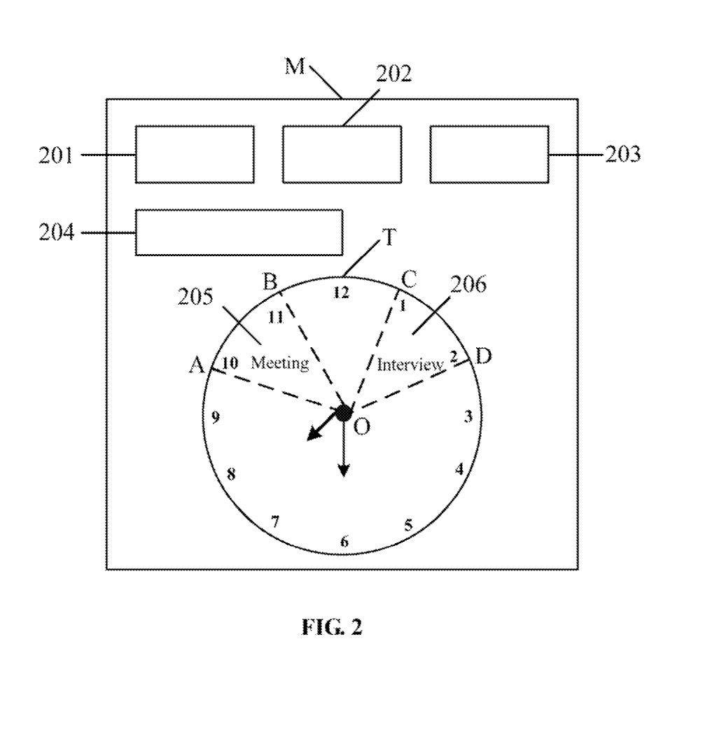

The displaying module 102 displays a user interface for the setting of the agenda, and displays an analog clock on the user interface. The user interface is displayed on the display screen 13. In one example, as shown in FIG. 2, the user interface M is displayed for the meeting and the interview, and an analog clock T is displayed on the user interface M. The user interface M includes a first display area 201 that displays all items of the agenda, a second display area 202 that displays expired items, a third display area 203 that displays current or unfinished items, and a fourth display area 204 that displays a current digital time of the analog clock T.

The determination module 103 determines an area on the analog clock for each of the items according to the time period allotted for each of the items, and displays a first color in each determined area of the items. For example, as shown in FIG. 2, the determination module 103 determines an area 205 (between points OAB) between 10 a.m. and 11 a.m. for the meeting item, and an area 206 (OCD) between 1 p.m. and 2 p.m. for the interview item. In the embodiment, each determined area of the items is initialized to the first color, such as grey. The name of each item in the agenda is displayed in a corresponding area of the analog clock.

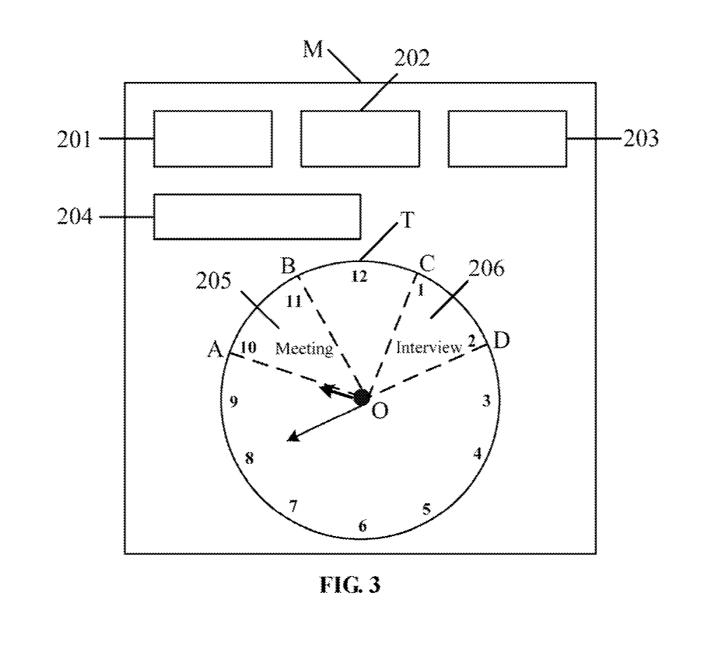

The notification module 104 notifies a user of the electronic device 1 when the alarm time of any item is reached, and displays a second color (e.g., green) in the determined area of the item. For example, as shown in FIG. 3, when the time reaches 9.40 a.m., the notification module 104 may generate a ringtone or a vibration using the electronic device 1 to notify the user to attend the meeting. Then, the notification module 104 displays the second color such as green in the area 205 to notify the user using the second color.

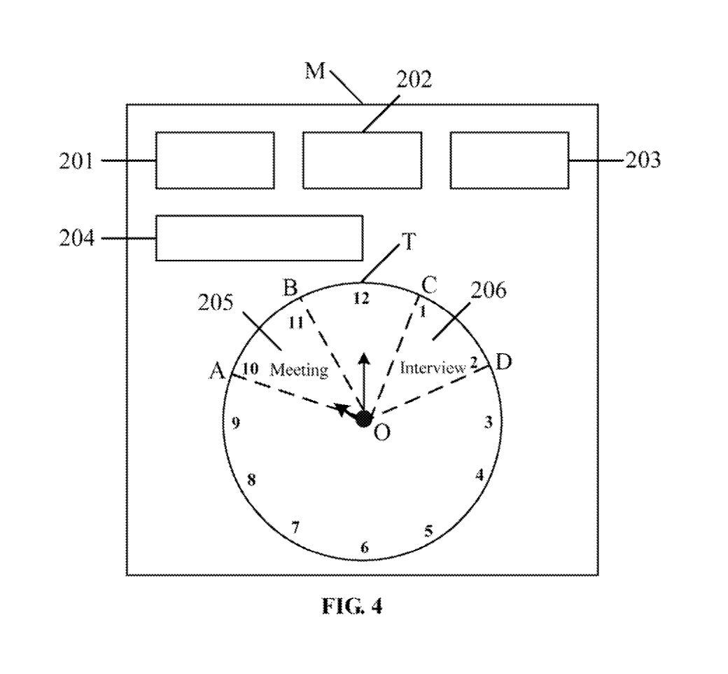

In addition, when the time period of any item in the agenda is reached, the notification module 104 displays a third color such as red in the determined area of the item, and generates the notification to remind the user. For example, as shown in FIG. 4, when the time reaches 10 a.m., the notification module 104 may display the third color in the area 205 for the meeting item of the agenda. Furthermore, when the time period of the item has elapsed, the notification module 104 changes the color of the determined area of the item to a background color (e.g., a low-intensity or semi-transparent color) in the user interface.

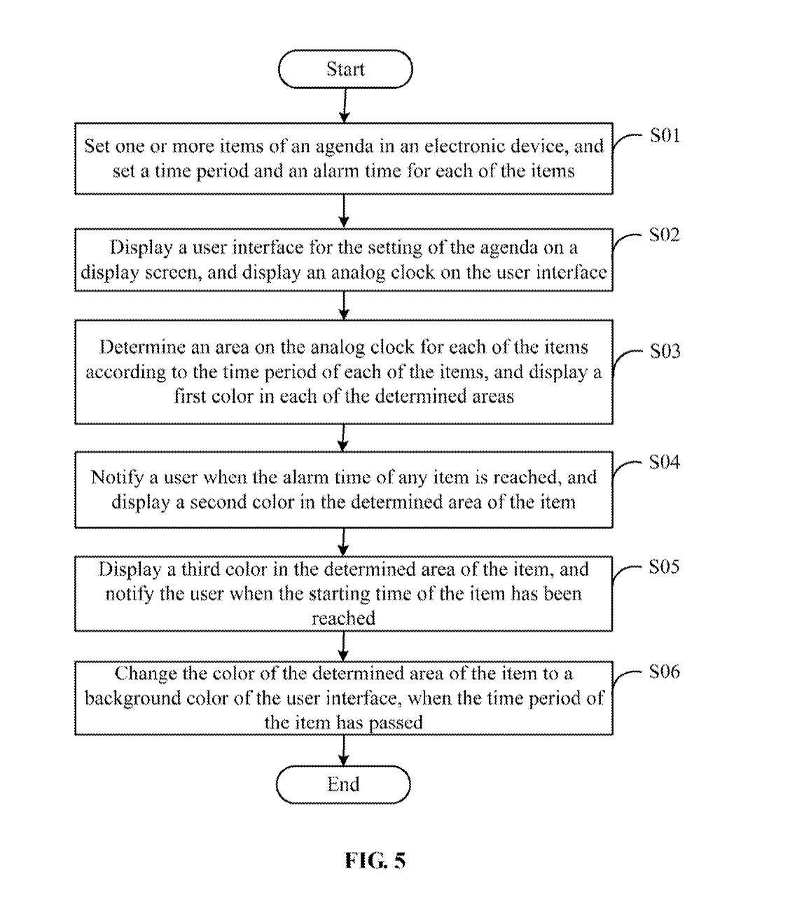

FIG. 5 is a flowchart of one embodiment of an agenda management method of the electronic device 1 of FIG. 1. Depending on the embodiment, additional blocks may be added, others removed, and the ordering of the blocks may be changed.

In block S01, the setting module 101 sets one or more items of an agenda in the electronic device 1, and sets an applicable time period and an alarm time for each of the items in the agenda.

In block S02, the displaying module 102 displays a user interface for the setting of the agenda, and displays an analog clock on the user interface. The displayed user interface includes a first display area 201 that displays all items of the agenda, a second display area 202 that displays lapsed or expired items, a third display area 203 that displays current or unfinished items, and a fourth display area 204 that displays the current digital time of the analog clock T.

In block S03, the determination module 103 determines an area on the analog clock for each of the items in the agenda according to the allotted time period of each item, and displays a first color in each determined area of the items. In the embodiment, each determined area of the items is initialized to the first color, such as grey.

In block S04, the notification module 104 notifies the user when the starting time of any item in the agenda is in the near future (the amount of any prior warning or alarm having been preset), as a visible or audible alarm, and displays a second color (e.g., green) in the determined area of the item.

In block S05, the notification module 104 displays a third color such as red in the determined area of the item, and notifies the user when the starting time of the item has been reached.

In block S06, the notification module 104 changes the color of the determined area of the item to a background color (e.g., a low-intensity or semi-transparent color) of the user interface, when the time period allotted for the item in the agenda has passed.

Although certain embodiments of the present disclosure have been specifically described, the present disclosure is not to be construed as being limited thereto. Various changes or modifications may be made to the present disclosure without departing from the scope and spirit of the present disclosure.

What is claimed is:

1. An agenda management method of an electronic device, the method comprising:
setting one or more items of an agenda in the electronic device, and setting a time period and an alarm time for each of the items in the agenda;
displaying a user interface for the setting of the agenda on a display screen of the electronic device, and displaying an analog clock on the user interface;
determining an area on the analog clock on the user interface for each of the items according to the time period of each of the items in the agenda, and displaying a first color in each of the determined areas on the user interface;
notifying a user of the electronic device when the alarm time of any item is reached, and displaying a second color in the determined area of the item on the user interface; and
displaying a third color in the determined area of the item on the user interface, and notifying the user when the starting time of the item has been reached.

2. The method according to claim 1, further comprising:
changing the color of the determined area of the item to a background color of the user interface, when the time period of the item has passed.

3. The method according to claim 1, wherein the user interface comprises a first display area that displays all of the set items, a second display area that displays lapsed or expired items, a third display area that displays current or unfinished items, and a fourth display area that displays a current digital time of the analog clock.

4. The method according to claim 1, wherein the user is notified using a ringtone or a vibration of the electronic device.

5. An electronic device, comprising:
a storage system;
at least one processor;
one or more programs stored in the storage system and executed by the at least one processor, the one or more programs comprising:
a setting module that sets one or more items of an agenda in the electronic device, and sets a time period and an alarm time for each of the items in the agenda;
a displaying module that displays a user interface for the setting of the agenda on a display screen of the electronic device, and displays an analog clock on the user interface;
a determination module that determines an area on the analog clock on the user interface for each of the items in the agenda according to the time period of each of the items, and displays a first color in each of determined areas on the user interface; and
a notification module that notifies a user of the electronic device and displays a second color in the determined area of an item when the alarm time of the item is reached, and displays a third color in the determined area of the item and notifies the user when the starting time of the item has been reached.

6. The electronic device according to claim 5, wherein the notification module further changes the color of the determined area of the item to a background color of the user interface, when the time period of the item has passed.

7. The electronic device according to claim 5, wherein the user interface comprises a first display area that displays all of the set items, a second display area that displays expired or lapsed items, a third display area that displays current or unfinished items, and a fourth display area that displays a current digital time of the analog clock.

8. The electronic device according to claim 5, wherein the user is notified using a ringtone or a vibration of the electronic device.

9. A non-transitory storage medium storing a set of instructions, the set of instructions capable of being executed by a processor of an electronic device, causes the electronic device to perform an agenda management method, the method comprising:
setting one or more items of an agenda in the electronic device, and setting a time period and an alarm time for each of the items in the agenda;
displaying a user interface for the setting of the agenda on a display screen of the electronic device, and displaying an analog clock on the user interface;
determining an area on the analog clock on the user interface for each of the items according to the time period of each of the items in the agenda, and displaying a first color in each of the determined areas on the user interface;

10. The non-transitory storage medium according to claim 9, wherein the method further comprises:
changing the color of the determined area of the item to a background color of the user interface, when the time period of the item has passed.

11. The non-transitory storage medium according to claim 9, wherein the user interface comprises a first display area that displays all of the set items, a second display area that displays expired or lapsed items, a third display area that displays current or unfinished items, and a fourth display area that displays a current digital time of the analog clock.

12. The non-transitory storage medium according to claim 9, wherein the user is notified using a ringtone or a vibration of the electronic device.
